(19) United States
(12) Patent Application Publication
(10) Pub. No.: US 2026/0065003 A1
(43) Pub. Date: Mar. 5, 2026

(54) IDENTIFYING SYSTEM CONFIGURATION USING ULTRA-VIOLET (UV) LIGHT

(71) Applicant: DELL PRODUCTS L.P., Round Rock, TX (US)

(72) Inventors: Michael Stumpf, Cedar Park, TX (US); Brian D. Kennedy, Rutland, MA (US); Sandor Farkas, Round Rock, TX (US)

(21) Appl. No.: 18/820,514

(22) Filed: Aug. 30, 2024

(51) Int. Cl. G06K 7/12; G06K 19/06

(52) U.S. Cl. CPC G06K 7/12; G06K 19/0614

(57) ABSTRACT

An information handling system may include a configuration detection system to identify different components within the information handling system by scanning one or more fluorescent based-markers on each of the components. A fluorescent based-marker is a labeling convention or a product code that uses a fluorescent dye on a barcode line, serial number, model number, fiducal marker, etc. to emit or reflect a different color wavelength when excited by an ultra-violet (UV) light. By using a preconfigured mapping table, the configuration detection system can determine one or more colors that correspond to the scanned fluorescent based-markers. The determined color or a combination of the determined colors can be used to identify each of the components in the information handling system.

### FIELD OF THE DISCLOSURE

The present disclosure generally relates to information handling systems and, more particularly, relates to identifying system configurations or components using an ultra-violet (UV) light and optical sensor.

### BACKGROUND

As the value and use of information continue to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use, such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may include a configuration detection system to identify multiple components within the information handling system by scanning one or more fluorescent based-markers on each of the components. A fluorescent based-marker may be a product code or a labeling convention that uses a fluorescent dye to emit or reflect a different color wavelength when excited by a narrow beam or a wide beam of UV light. For example, the configuration detection system may scan the one or more fluorescent based-markers using sweeping UV light and then receive reflected light of different intensities. The configuration detection system may use a coordinates table to determine the coordinates that correspond to the reflected light intensities. The configuration detection system may then utilize a preconfigured mapping table to determine one or more colors that are associated with each of the determined coordinates. The determined color or a combination of the determined colors may be representative of the identification of each component in the information handling system. For example, the determined color may be representative of a fiducal marker or a particular barcode label of a component. In another example, a combination of the determined colors may be representative of the barcode label of another component.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1A is a block diagram of an information handling system and a portion of the information handling system according to at least one embodiment of the present disclosure;

FIG. 1B is a block diagram of the information handling system and a portion of the information handling system according to at least one embodiment of the present disclosure;

FIG. 2 is an example mapping of colored tapes to a 2D chart graph to identify coordinates and line segments that will be used in a preconfigured mapping table according to at least one embodiment of the present disclosure;

FIG. 3 is an example of a preconfigured mapping table that corresponds to the mapped colored tapes on the 2D chart graph according to at least one embodiment of the present disclosure;

FIG. 4A is a flow diagram of a method for identifying system configuration using a sweeping, narrow beam of UV light according to at least one embodiment of the present disclosure;

FIG. 4B is a flow diagram of a method for identifying system configuration using a wide beam of UV light according to at least one embodiment of the present disclosure; and

FIG. 5 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

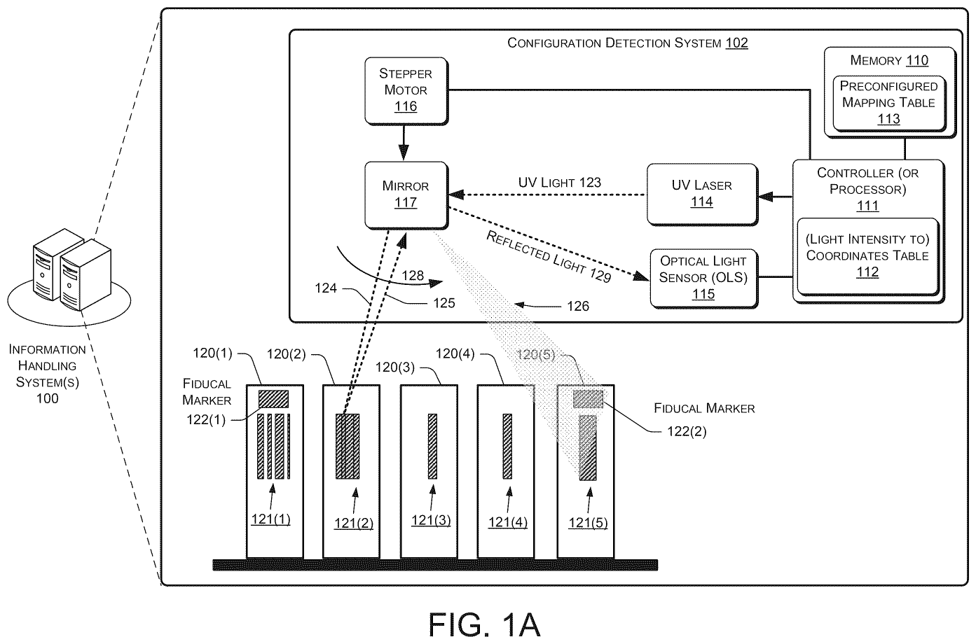

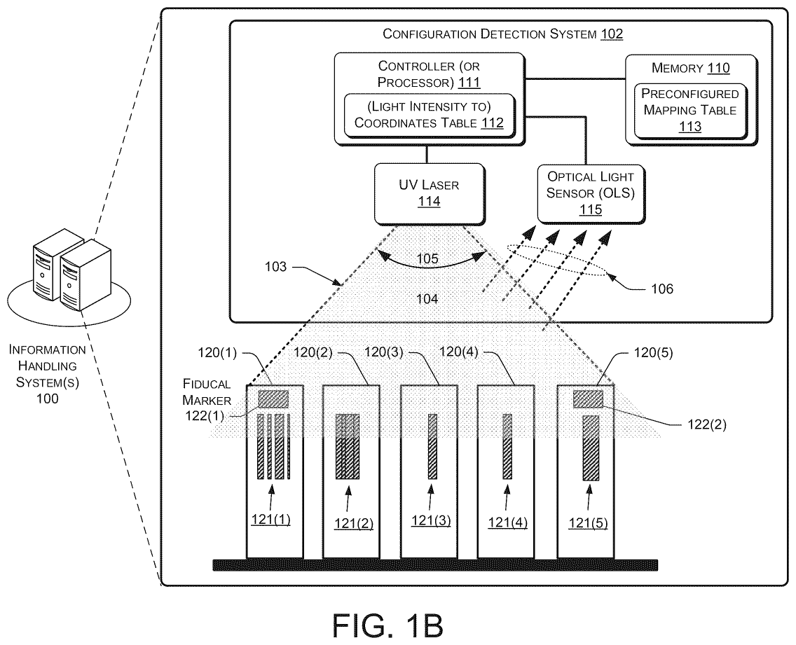

FIG. 1A illustrates an information handling system 100 including a configuration detection system 102, according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, the information handling system 100 may represent a computer system, such as a laptop computer, a desktop computer, a computer workstation, a server system, a blade server system, or other rack-mounted computer equipment, such as a storage server, a network server, a network switch/router, or other datacenter computer equipment, or other electronic equipment generally defined, but being characterized as including the configuration detection system 102 to identify the configuration or components using a sweeping narrow beam of ultra-violet (UV) light, a single static spread-out beam of UV light, or a sweeping multiple wide beams of UV light that can be focused on different areas, as described below. The configuration detection system 102 may be configured to detect and identify one or more fluorescent based-markers on each of the installed components in the information handling system 100. By using the sweeping narrow beam and/or the wide beams of UV lights, for example, the configuration detection system 102 may determine one or more colors associated with received reflected lights. The configuration detection system 102 may then use the determined color or a combination of the determined colors to identify each of the components in the information handling system.

In an embodiment, the configuration detection system 102 may include, without limitation, a memory 110, a controller (or processor) 111, a stored (light intensities to x-y) coordinates table 112, the memory 110 may store a preconfigured mapping table 113, a UV laser 114, an optical light sensor (OLS) 115, a stepper motor 116, and a mirror 117. In certain examples, the mirror 117 may be any combination of multiple mirrors without varying from the scope of this disclosure.

The configuration detection system 102 may be used to identify a plurality of installed components 120(1)-120(5) using their respective fluorescent based-markers 121(1)-120(5). The installed components, for example, may include a Dual In-Line Memory Module (DIMM), a heat exchanger, a solid-state drive, etc. The configuration detection system 102 may further use fluorescent based-fiducal markers 122(1) and 122(2) to further identify an area within the information handling system 100, system components, and/or use the fiducal markers as reference points for the scanning of the fluorescent based-markers 121(1)-120(5). The various elements of the configuration detection system 102 may be understood to be contained within the information handling system 100, or one or more of the elements of the configuration detection system 102 may be understood to be external to the information handling system, as needed or desired.

The UV laser 114 may represent a light-emitting diode (LED) or LED array that emits light in a UV spectrum. The UV light includes a light wavelength of about 100 to 400 nanometers. The UV laser 114 can emit sufficient power of UV light to scan a particular area in the information handling system 100, and may include a collimating lens, as needed or desired, to scan the particular area using a narrow beam or a wide beam of UV light. The narrow beam or wide beam of UV light may include an amount of divergence or spread of the UV light when scanning or illuminating the fluorescent based-markers 121(1)-120(5) and/or fiducal markers 122(1)-122(2) to be detected.

For narrow UV beams, which can be used to directly detect the presence or absence of colored objects from each of the fluorescent based-markers 121(1)-120(5) and fiducal markers 122(1)-122(2), the collimating lens (not shown) may include a short focal length and a large diameter to focus a UV light 123 to a particular area or a smaller spot size on the components 120(1)-120(5). For wider UV beams, which can be used to detect multiple colors from an averaging effect of a single pixel representation, the collimating lens may include a longer focal length and a small diameter to concentrate the UV light 123 to a wider and more spread-out beam. The wider beam of UV light may illuminate the components 120(1)-120(5) at the same time, or each of the components 120(1)-120(5) can be scanned using a single spread-out beam of the UV light (shown by arrow 126). In this regard, the mirror 117 may include multiple mirrors of different collimating lenses to scan the components 120(1)-120(5) using the narrow beams of UV light, the wider beam of UV light, or a combination thereof, as desired or needed. In some embodiments, the controller 111 may control the use of a narrower and/or wider beam of UV lights when scanning or illuminating the fluorescent based-markers 121(1)-120(5) and/or the fiducal markers 122(1)-122(2).

For example, the UV laser 114 may emit the UV light 123 that can be aimed at the mirror 117, which can include collimating lenses with a short focal length and a large diameter (for a narrower beam) to reflect 124 the UV light 123 to a particular area or spot on the component 121(2). In this example, the UV light 123 is reflected 124 towards the plurality of components 120(1)-120(5) in a sweeping manner and using a narrower beam of UV light. The UV light 123 may be reflected 124 towards the components 120(1)-120(5) from left to right, right to left, or any other preconfigured direction that aligns with pre-identified locations of the components in the information handling system 100. In this example, the narrow beam of UV light can be used to directly detect the presence or absence of the fluorescent based-markers on a particular targeted area or focused spot on the components 120(1)-120(5). For example, the narrow beam of UV light can be used to target each of the four individual barcode lines of the fluorescent based-marker 121(1), as shown.

In another example, the UV laser 114 may emit the UV light 123 that can be aimed at the mirror 117, which includes a collimating lens with a longer focal length and a small diameter (for spread-out beam) to reflect the UV light 123 to a wider area or spot on the components 120(1)-120(5). For example, the UV light 123 may be reflected 126 towards each of the components 120(1)-120(5) in a sweeping manner, but using a wider beam of UV light to cover each of the component rather than each barcode line on the component. Here, the UV light 123 may be reflected 126 towards the components 120(1)-120(5) using multiples of a wider beam of UV light that can be focused at different subdivided areas, such as the respective locations of each of the components 120(1)-120(5). The wider beam of UV light (reflection 126) may be used to detect multiple colors from an averaging effect of a single pixel representation, which can be detected using a single pixel OLS device, for example.

The stepper motor 116 includes an electric motor that can be controlled by the controller 111 to move in discrete steps, or increments, in a particular direction, as needed or desired. For example, the stepper motor 116 can move in precise and fixed angular increments to accurately position the mirror 117, which is mechanically attached to the stepper motor 116.

Thus, by sequentially actuating the stepper motor 116 to reorient the mirror 117, the UV light 123 can be reflected, in the direction of arrow 128, towards the components 120(1)-120(5) or other areas in the information handling system 100 in a controlled direction and/or increments.

The stepper motor 116 may also facilitate a movement of the mirror 117 at a particular direction or angle when using the wide beam of UV light to scan the components 120(1)-120(5) or other areas in the information handling system 100. In some embodiments, instead of the stepper motor 116, a coil driven mechanism may be utilized to reorient the mechanically attached mirror 117. In a particular embodiment, and as further described in details in FIG. 1B, the UV laser 114 may directly emit the spread-out UV light 123 towards the components 120(1)-120(5) without the need of the stepper motor 116 and/or the mirror 117.

Each of the fluorescent based-markers 121(1)-120(5) includes a labeling convention or product code that uses a fluorescent dye on a barcode line or each of the barcode lines, a serial number, or a model number to emit, in the direction of arrow 125, a different color wavelength when excited by the UV light 123. A serial number or component model, for example, can include fluorescent based-numbers and/or fluorescent based-letters. For illustration purposes, each of the fluorescent based-markers 121(1)-120(5) shows one or more fluorescent based-barcode lines (also referred to herein as fluorescent based-markers) that emit 125 a light of particular wavelength depending upon a molecular structure of the fluorescent based-barcode line. For example, a particular fluorescent based-barcode line of a particular color absorbs the UV light 123 at a particular time instant and emits, in the direction of arrow 125, a reflected light 129 that is received by the OLS 115. A single or a combination of fluorescent based-barcode lines can be representative of a barcode label that may be associated with the component. For example, the label for the component 120(1) includes a combination of four fluorescent based-barcode lines as illustrated, while each of the components 120(3)-120(5) may respectively include a different color of fluorescent based-barcode line.

In a particular embodiment, the controller 111 may use the stepper motor 116 to control the timing of the sweeping scan to differentiate the location of the components between slots. For example, each of the components 120(1)-120(5) is scanned with a narrow beam of UV light at a particular range, direction, and/or angle of the mirror 117. In this example, the stepper motor 116 may control the direction and timing of the movement of the mirror 117 when scanning each of the fluorescent based-markers 121(1)-120(5). The narrow beam of UV light may individually target each barcode line on each of the fluorescent based-markers 121(1)-120(5). The targeted barcode line may correspondingly emit the reflected light 129 that can be directly detected by the controller 111 based on their corresponding coordinates.

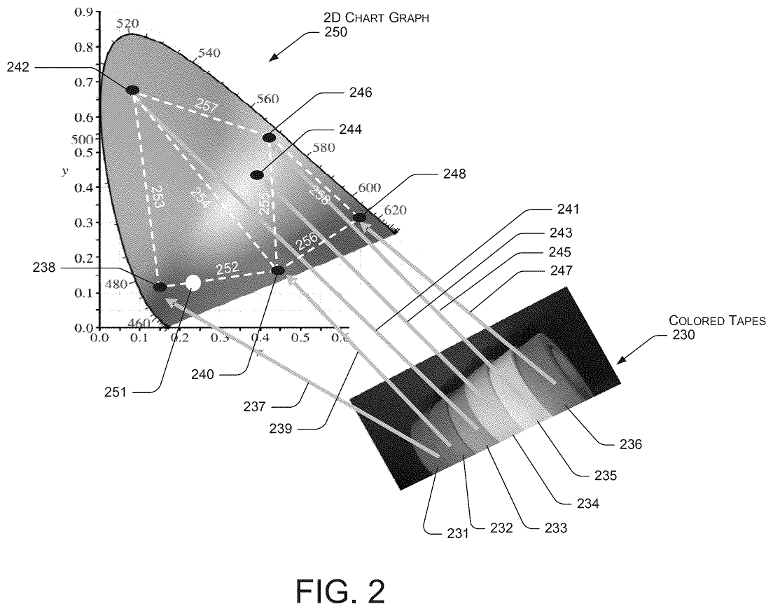

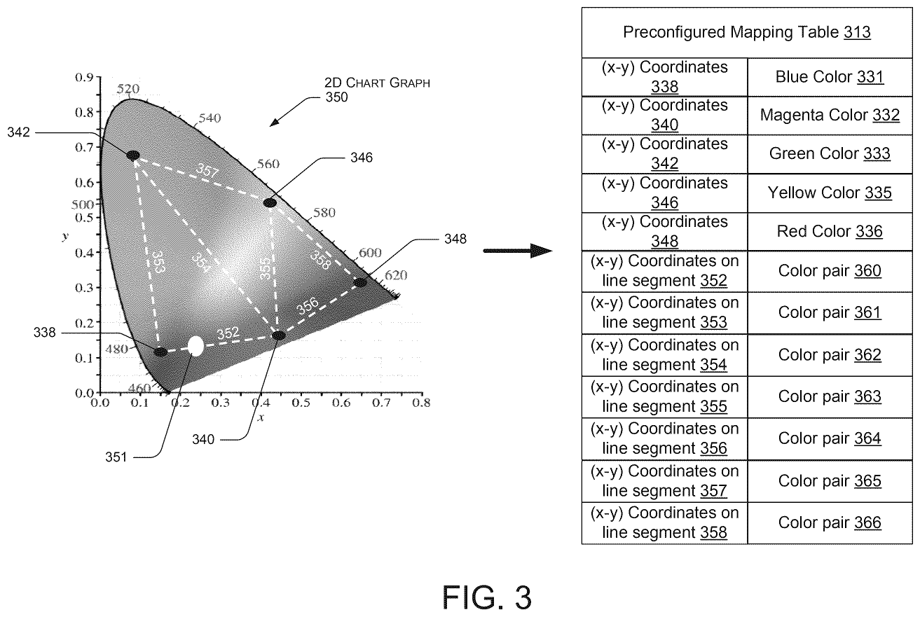

In another embodiment, the controller 111 may use the UV laser 114 to target each of the fluorescent based-markers 121(1)-120(5) with a sweeping wider beam of UV light. The wider beam of UV light may be used to identify the single pixels that can be associated with multiple colors. These single pixels may include the determined coordinates that lie on the created line segments as described herein. These line segments may be created by corresponding color pairs that are selected and mapped to a 2D chart graph as further described in FIGS. 2-3 below.

Each of the fiducal markers 122(1)-122(2) may similarly include a labeling convention that uses the fluorescent dye to emit 125 a different color wavelength when excited by the UV light 123. The fiducal marker can be a fluorescent based-barcode line, a fluorescent based-number, a fluorescent based-letter, or any fluorescent based-material of any shape that can be used as reference points during the scanning of the fluorescent based-markers 121(1)-120(5). The fiducal marker can be placed along the fluorescent based-marker(s) in the same component, or it can be separately located on other parts of the information handling system 100.

For example, the fiducal marker 122(1) may indicate a first slot, while the fiducal marker 122(2) can indicate a last slot. In this example, the fiducal markers 122(1) and 122(2) can be placed on the components 120(1) and 120(5), respectively. In another example, the fiducal marker 122(1) may indicate a reference point for the starting scan, while the fiducal marker 122(2) can indicate a reference point for the end scan. In this example, the fiducal markers 122(1) and 122(2) need not be placed on the components but can be located in other areas of the information handling system 100.

OLS 115 may include, without limitation, a single pixel device that can detect photons (light particles) from the reflected light 129 that will hit the optical light sensor's active area (not shown). The OLS 115 may then convert the energy from the detected photons into an electrical signal that can be measured and interpreted by electronic circuits such as the OLS 115 or the controller 111. The strength of the electrical signal correlates with the intensity of the reflected light 129, thereby allowing for precise measurements.

For example, the OLS 115 may indirectly detect a fluorescent color by measuring the light intensity of the reflected light 129 emitted by a particular fluorescent based-marker or the fiducal marker. In this example, the particular fluorescent based-marker or the fiducal marker may include a particular width, molecular component, or a combination thereof, to emit a particular intensity that can be measured and transformed into numerical coordinates. In some embodiments, the controller 111 may use the coordinates table 112 to determine the coordinates of the corresponding light intensities that the controller 111 receives via the OLS 115. In other embodiments, the coordinates table 112 is utilized by the OLS 115 to directly report the determined coordinates to the controller 111. The coordinates table 112 may include a mapping of different light intensities to their corresponding coordinates in 2D space. For example, a particular intensity of the reflected light 129 may correspond to a particular point on a 2D chart graph.

Preconfigured mapping table 113 in the memory 110 may include a mapping of one or more colors to corresponding distinct coordinates in a chart graph. The mapped colors in the preconfigured mapping table are representative of the scanned fluorescent based-markers. In an embodiment, the determined coordinates may correspond to a single color or correspond to multiple colors. The determined coordinates of a single pixel that lie on a line segment formed by a pair of colors, as further described in detail in FIG. 2, may correspond to multiple colors.

Here, the controller 111 may communicate with the memory 110 to utilize the preconfigured mapping table 113 to determine the one or more colors associated with each of the coordinates, which were determined using the coordinates table 112. The controller 111 may then use the determined color or a combination of the determined colors to identify each of the plurality of components 120(1)-120(5).

In some embodiments, the coordinates table 112 may include a mapping of the colors to corresponding coordinates in the 2D space. In this case, the controller 111 may use the coordinates table 112 to directly detect the colors of the determined coordinates without the need of the preconfigured mapping table 113. For example, the controller 111 may use the narrow beam of UV light 123 to scan each of the barcode lines on the components 120(1)-120(5) and then utilize the coordinates table 112 to directly detect the corresponding barcode line colors.

Components 120(1)-120(5) may include hardware components that work together to process or store data. For example, the component can be a processor, memory, storage, network interface card (NIC), motherboard, power supply unit (PSU), and the like. In this example, each component can include a fluorescent based-marker (one barcode line) or a plurality of fluorescent based-markers (combination of barcode lines) for tracking and/or identification purposes. In some embodiments, the barcode lines (fluorescent based-markers) can be placed adjacent to one another since a combination of determined colors can be used to identify the corresponding component.

FIG. 1B illustrates another embodiment of the information handling system 100 including the configuration detection system 102, according to at least one embodiment of the present disclosure. FIG. 1B shows the UV laser 114 that may directly emit 103 a wide beam of UV light 104 towards the components 120(1)-120(5). As compared to FIG. 1A above, FIG. 1B illustrates the detection of the one or more fluorescent based-markers without the need of the stepper motor 116 and the mirror 117. Here, the UV laser 114 may emit 103 a single and static wide beam of UV light 104 with an angular of distribution as shown by arrow 105. The OLS 115 may then receive reflected lights 106, which can be further processed by the controller 111 to determine the colors associated with received reflected lights.

For example, an average of two different colors of barcode lines on fluorescent based-marker 121(1) may be represented by a single detected pixel. In this example, the controller 111 may use the single and static wide beam of UV light 104 with an angular distribution as shown by arrow 105 to detect the average of these two different colors of barcode lines. The controller 111 may then use the preconfigured mapping table 113 to identify the multiple colors, which can be representative of the detected single pixel.

FIG. 2 illustrates an example mapping of colored tapes 230 to a 2D chart graph 250 to identify the coordinates and line segments that will be used in the preconfigured mapping table according to at least one embodiment of the present disclosure. In certain examples, colored tapes 230 may be any suitable colored material, such as a paint, without varying from the scope of this disclosure. The mapping of the different colored tapes 230 may be used to create the preconfigured mapping table, such as the preconfigured mapping table 113 of FIG. 1. The preconfigured mapping table may be used to determine one or more colors associated with each of the coordinates, which are determined using the coordinates table, such as the coordinates table 112 of FIG. 1. The determined color or a combination of the determined colors can then be used to identify the label or product code on each of the components, such as the plurality of components 120(1)-120(5) of FIG. 1.

The colored tapes 230 may include different colors that can be further filtered and/or processed to select the colors that will be used in the preconfigured mapping table, as further described in details below.

In an embodiment, the filtering process may include dropping one or more ambiguous colors and/or line segments that intersect another line segment on the 2D chart graph 250. The filtering process may initially include a mapping of each color in the colored tapes 230 to a specific unique location on the 2D chart graph 250. For example, the colored tapes 230 include a blue color 231, magenta color 232, green color 233, orange color 234, yellow color 235, and a red color 236. The blue color 231 is mapped 237 to (x-y) coordinates 238; magenta color 232 is mapped 239 to (x-y) coordinates 240; green color 233 is mapped 241 to (x-y) coordinates 242; orange color 234 is mapped 243 to (x-y) coordinates 244; yellow color 235 is mapped 245 to (x-y) coordinates 246; and the red color 236 is mapped 247 to (x-y) coordinates 248. As defined herein, the coordinates, such as coordinates 238 can be representative of a point in a two-dimensional plane. For example, the coordinates 238 is representative of a single pixel in the 2D chart graph 250.

As shown, the orange color 234 is ambiguous with the yellow color 235 and magenta color 232 pair, and also ambiguous with the red color 236 and green color 233 pair. Accordingly, the orange color 234 and its associated coordinates 244 may not be used in the coordinates table and/or the preconfigured mapping table when the yellow color 235 and magenta color 232 pair or the red color 236 and green color 233 pair are also used. Further, the blue color 231 and yellow color 235 pair may not be used to form a line segment because the line segment created by this pair will cross the line segment formed by connecting the green color 233 and magenta color 232 pair. Further still, the blue color 231 and red color 236 pair is not used to form another line segment because this pair will cross the line segment formed by connecting the magenta color 232 and the green color 233 pair.

In a particular non-limiting embodiment, only 5 colors in the colored tapes 230 and only 7 valid pairs of different colors in the illustrated example may be used to create the line segments that can be used to identify multiple colors from a single pixel-coordinates. For example, a particular x-y coordinates 251 is representative of the single pixel that lies on a line segment 252 may correspond to the blue color 231 and the magenta color 232. Stated another way, each of line segments 252-258 may facilitate the determination of multiple colors based on a single pixel-coordinates. In a case where the single pixel-coordinates is the same as one of the coordinates 238, 240, 242, 246, or 248, then the single pixel is directly identified by its exact x-y coordinates, i.e., blue color 231, green color 233, etc.

In some embodiments, an algorithm may be used to determine the number of non-crossing line segments for a given particular number of colors that are mapped in the 2D chart graph 250. For example, the algorithm uses a formula, “2N−3” where N is the particular number of colors selected (and not dropped) from the colored tapes 230. Referencing “N” to be 5, where the orange color 234 is dropped as discussed above, the number of non-crossing line segments would be 2(5)−3=7. Each of these seven-line segments may facilitate the determination of multiple colors based on single pixel-coordinates, as further described in details below.

FIG. 3 illustrates an example preconfigured mapping table 313 that can be created from a created 2D chart graph 350 according to at least one embodiment of the present disclosure. The preconfigured mapping table 313 and the 2D chart graph 350 correspond to the preconfigured mapping table 113 of FIGS. 1 and 2D chart graph 250 of FIG. 2, respectively.

In an embodiment, the preconfigured mapping table 313 may be used to determine the one or more colors associated with each of the determined coordinates of the detected reflected lights, as discussed above. As shown, the preconfigured mapping table 313 may include exact (x-y) coordinates such as coordinates 338, 340, 342, 346, and 348 that correspond to blue color 331, magenta color 332, green color 333, yellow color 335, and red color 336, respectively. Here, each of the coordinates 338, 340, 342, 346, and 348 may correspond to only one corresponding color, which includes the same coordinates. These coordinates 338, 340, 342, 346, and 348 can be tracked using the narrow beam of UV light as described herein. However, when the determined (x-y) coordinates lie on one of line segments 352-358, then the determined (x-y) coordinates (or single pixel) may be associated with multiple colors. The determined (x-y) coordinates on one of line segments 352-358 can be tracked using the wide beam of UV light that can be used to determine an average of at least two colors.

For example, when a particular coordinate 351 (white circle) is determined to be a point on a line segment 352 that is formed by connecting the blue color 331 and magenta color 332 pair, then the particular coordinate 351 can be associated with these multiple colors (blue and magenta colors). On the other hand, if the particular coordinate 351 is determined to be a point on a line segment 353 that can be formed by connecting the blue color 331 and green color 333 pair, then the particular coordinate 351 can be associated with these multiple colors (blue and green colors), and so on. The particular coordinate 351 can be tracked using the wide beam of UV light, such as the wide beam of UV light 104 in FIG. 1B, which can be used to determine the average of the corresponding color pairs. The line segments 353-358 correspond to the formed line segments 252-258 of FIG. 2. Each of color pairs 361-366 may include the pair of colors that are connected to form the corresponding line segments. In a case where the particular coordinate 351 is determined to be a point outside of the line segments 353-358 or is not one of the coordinates 338, 340, 342, 346, and 348, then the particular coordinate 351 is not associated with any color in the preconfigured mapping table 313.

In some embodiments, the blue color 331, magenta color 332, green color 333, yellow color 335, and the red color 336 can be detected using the narrow beam of UV light from the UV laser, such as the UV laser 114 of FIG. 1A or 1B. In another embodiment, each of the color pairs 361-366 may be representative of a corresponding average color that can be detected using the wide beam of UV light. In alternative embodiments, the coordinates and the one or more corresponding colors in the preconfigured mapping table 313 can be detected using a combination of the narrow beam and wide beam of UV lights. The configuration detection system, such as the configuration detection system 102 of FIG. 1, may control the timing and the amount of spread of the UV light when implementing the narrow beam and wide beam of UV lights to scan or illuminate the fluorescent based-markers.

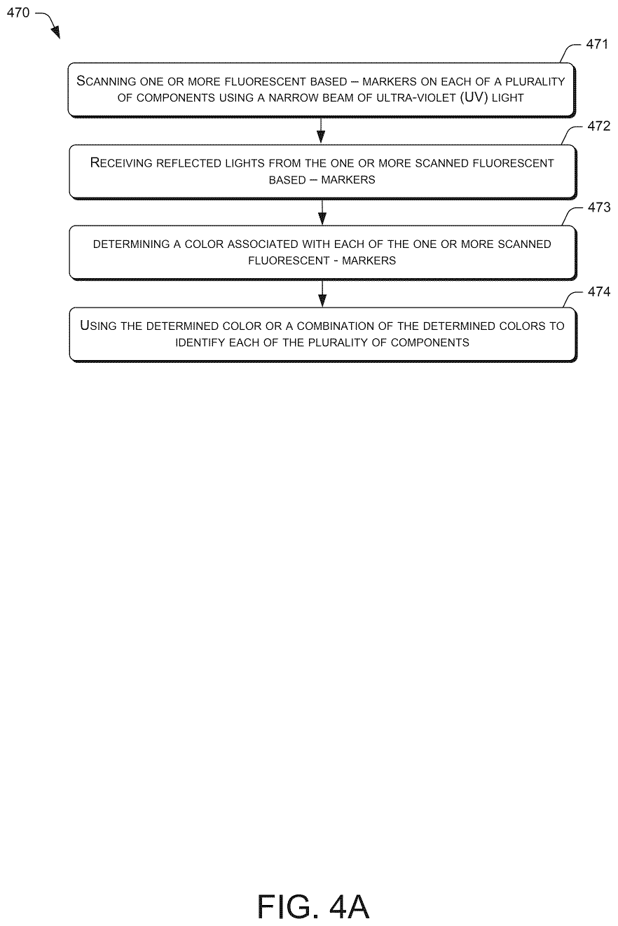

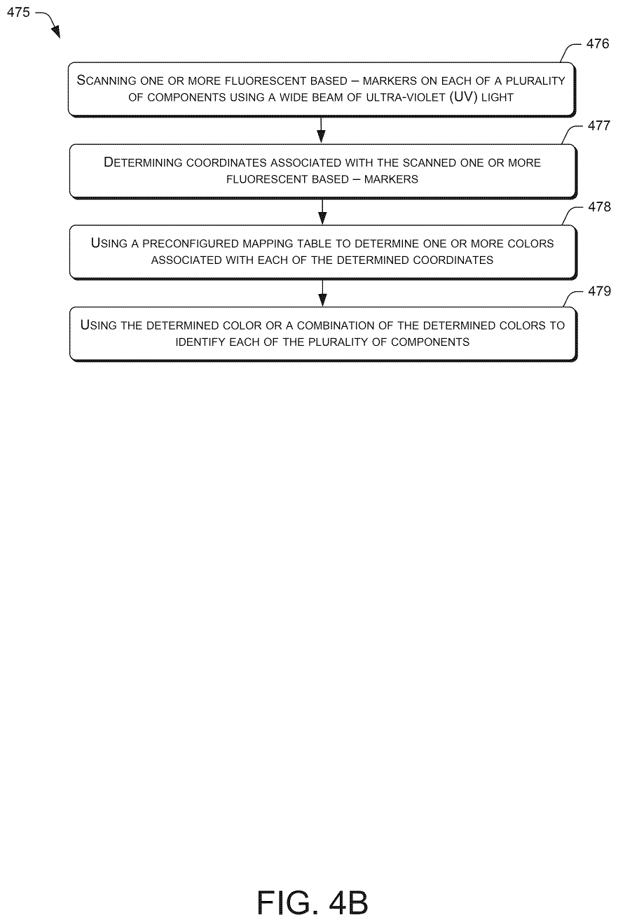

FIG. 4A is a flow diagram of a method 470 for identifying system configuration or components with the use of a sweeping, narrow beam of UV light according to at least one embodiment of the present disclosure, starting at step 471. It will be readily appreciated that not every method step set forth in this flow diagram is always necessary, and that certain steps of the methods may be combined, performed simultaneously, in a different order, or perhaps omitted, without varying from the scope of the disclosure. FIG. 1A/1B may be employed in whole, or in part, by a controller or processor 111 of the information handling system 100 of FIG. 1A/1B, or any other type of controller, device, module, processor, or any combination thereof, operable to employ all, or portions of, the method of FIG. 4A.

At step 471, the processor and/or controller may scan one or more fluorescent based-markers on each of a plurality of components using a narrow beam of UV light. For example, the fluorescent based-marker is a fluorescent-based barcode line that can be used to label a component. In this example, the narrow beam of UV light may be used to scan each of fluorescent-based barcode lines as described in FIG. 1A.

At step 472, the processor and/or controller may receive reflected lights from the one or more scanned fluorescent based-markers. At step 473, the processor and/or controller may, based on the received reflected lights, determine a color that is associated with the scanned one or more fluorescent based-markers. For example, based on the coordinates table, such as the coordinates table 112 of FIG. 1A, the processor and/or controller may directly detect or determine the color that can be associated with the received reflected lights. In other embodiments, the processor and/or controller may use the preconfigured mapping table to directly detect the color that can be associated with the scanned one or more fluorescent based-markers. For example, the blue color 331 of the preconfigured mapping table 313 of FIG. 3 may be directly detected based on the determined (x-y) coordinates 338.

At step 474, the processor and/or controller may use the determined color or a combination of the determined colors to identify each of the plurality of components.

FIG. 4B is a flow diagram of a method 475 for identifying system configuration or components with the use of a wide beam of UV light according to at least one embodiment of the present disclosure, starting at step 476. It will be readily appreciated that not every method step set forth in this flow diagram is always necessary, and that certain steps of the methods may be combined, performed simultaneously, in a different order, or perhaps omitted, without varying from the scope of the disclosure. FIG. 1A/1B may be employed in whole, or in part, by a controller or processor 111 of the information handling system 100 of FIG. 1, or any other type of controller, device, module, processor, or any combination thereof, operable to employ all, or portions of, the method of FIG. 4B.

At step 476, the processor and/or controller may scan one or more fluorescent based-markers on each of a plurality of components using a wide beam of UV light. For example, the processor and/or controller may use a single static and spread-out UV light, such as the wide beam UV light 104 of FIG. 1B, to scan or illuminate the fluorescent based-markers on each of a plurality of components. At 477, the processor and/or controller may determine coordinates associated with the scanned one or more fluorescent based-markers.

At step 478, the processor and/or controller may use a preconfigured mapping table to determine one or more colors associated with each of the determined coordinates. For example, referring to FIG. 3, the identified x-y coordinates correspond to a pixel that lies on the line segment 352. Accordingly, the single pixel can be associated with multiple colors, such as the blue and magenta colors that form the line segment 352. In another example, the identified x-y coordinates correspond to a pixel that is exactly the same as the x-y coordinates 338. Accordingly, this single pixel can be associated with the blue color 331 that is associated with coordinates 338 as shown in the preconfigured mapping table 313 of FIG. 3.

At step 479, the processor and/or controller may use the determined color or a combination of the determined colors to identify each of the plurality of components. In some embodiments, the processor and/or controller may scan the one or more fluorescent based-markers on each of a plurality of components using a combination of the wide beam and narrow beam of UV lights.

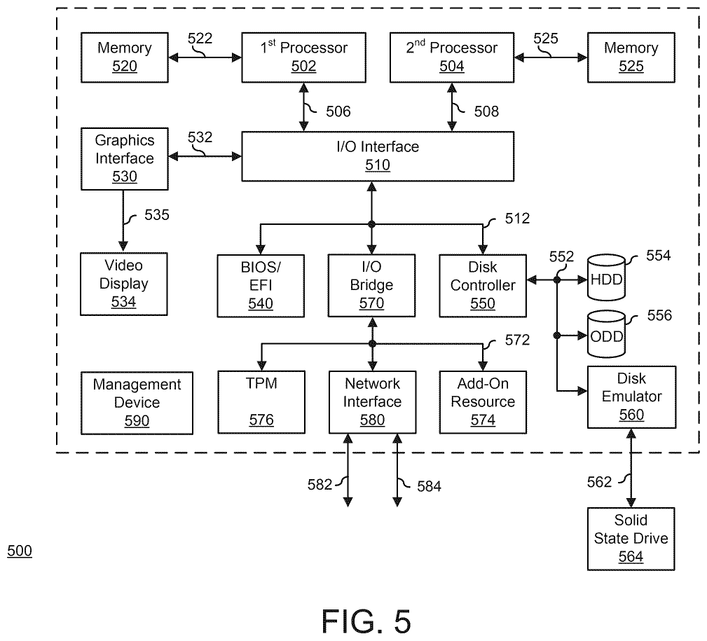

FIG. 5 shows a generalized embodiment of an information handling system 500 according to an embodiment of the present disclosure. Information handling system 500 may be substantially similar to information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below and operate to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 564, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 564, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532 and provides a video display output 536 to a video display 534. In a particular embodiment, information handling system 500 includes separate memories that are dedicated to each of processors 502 and 504 via separate memory interfaces. An example of memories 520 and 530 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 4394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512 or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof.

Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500.

Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A configuration detection system comprising:
a memory to store a preconfigured mapping table; and
a controller coupled to the memory, the controller configured to:
scan one or more fluorescent based-markers on each of a plurality of components;
determine coordinates associated with the scanned one or more fluorescent based-markers;
based on the preconfigured mapping table, determine one or more colors associated with each of the determined coordinates; and
based on the determined color or a combination of the determined colors, identify each of the plurality of components.

2. The configuration detection system of claim 1, wherein the one or more fluorescent based-markers emit different color wavelength when excited with an ultra-violet (UV) light.

3. The configuration detection system of claim 1, wherein the configuration detection system further comprises:
a UV laser that emits an ultra-violet (UV) light;
a mirror mechanically coupled to a stepper motor to scan the one or more fluorescent based-markers using the UV light; and
an optical light sensor (OLS) that receives reflected lights in response to the scanning of the one or more fluorescent based-markers.

4. The configuration detection system of claim 3, wherein the controller utilizes a coordinates table to determine the coordinates associated with the received reflected lights from the scanned one or more fluorescent based-markers.

5. The configuration detection system of claim 4, wherein the coordinates table includes a mapping of different light intensities to corresponding coordinates in a two-dimensional (2D) chart graph.

6. The configuration detection system of claim 1, wherein the controller is further configured to use a fiducal marker that is used as a reference point for the scanning of the one or more fluorescent based-markers on each of the plurality of components.

7. The configuration detection system of claim 6, wherein the fluorescent based-markers are placed adjacent to one another.

8. The configuration detection system of claim 1, wherein the preconfigured mapping table includes a mapping of the one or more colors to distinct coordinates in a chart graph.

9. The configuration detection system of claim 8, wherein the preconfigured mapping table includes a line segment.

10. The configuration detection system of claim 9, wherein a single pixel having coordinates that lies on the line segment represents multiple colors.

11. A method comprising:
scanning, by a controller, of one or more fluorescent based-markers on each of a plurality of components;
determining, by the controller, coordinates associated with the scanned one or more fluorescent based-markers;
based on a preconfigured mapping table, determining one or more colors associated with each of the determined coordinates; and
based the determined color or a combination of the determined colors, identifying each of the plurality of components.

12. The method of claim 11, wherein the scanning of the one or more fluorescent based-markers on each of the plurality of components, the method further comprises:
emitting an ultra-violet (UV) light;
sweeping the one or more fluorescent based-markers using the UV light; and
receiving reflected lights in response to the scanning of the one or more fluorescent based-markers.

13. The method of claim 11, wherein the determining coordinates associated with the scanned one or more fluorescent based-markers, the method further comprises:
utilizing a coordinates table to identify the coordinates.

14. The method of claim 13, wherein the coordinates table includes a mapping of different light intensities to corresponding x-y coordinates in a two-dimensional (2D) chart graph.

15. The method of claim 11, wherein the scanning, the method further comprises: scanning of a fiducial marker that is used as a reference point for the scanning of the one or more fluorescent based-markers on each of the plurality of components.

16. The method of claim 11, wherein a combination of the plurality of fluorescent based-markers forms a barcode label that is used to identify a particular component.

17. The method of claim 11, wherein the preconfigured mapping table includes a mapping of the one or more colors to distinct coordinates in a chart graph.

18. An information handling system comprising:
a plurality of components; and
a configuration detection system further comprising:
a memory to store preconfigured mapping table; and
a controller coupled to the memory, the controller configured to:
scan one or more fluorescent based-markers on each of the plurality of components;
determine coordinates associated with the scanned one or more fluorescent based-markers;
based on the preconfigured mapping table, determine one or more colors associated with each of the determined coordinates; and
based on the determined color or a combination of the determined colors, identify each of the plurality of components.

19. The information handling system of claim 18, wherein the one or more fluorescent based-markers are scanned using a narrow beam of ultra-violet (UV) light, a wide beam of UV light, or a combination thereof.

20. The information handling system of claim 19, wherein the configuration detection system further comprises:
a UV laser that emits the narrow beam of UV light;
a mirror mechanically coupled to a stepper motor to scan the one or more fluorescent based-markers using the narrow beam of UV light; and
an optical light sensor (OLS) that receives reflected lights in response to the scanning of the one or more fluorescent based-markers.
